(19) United States
(12) Patent Application Publication
(10) Pub. No.: US 2025/0389914 A1
(43) Pub. Date: Dec. 25, 2025

(54) MULTI-CHANNEL LIGHT RECEIVING/TRANSMITTING ASSEMBLY AND OPTICAL MODULE

(71) Applicant: InnoLight Technology (Suzhou) Ltd., Suzhou , Jiangsu (CN)

(72) Inventors: Zhenzhong WANG, Suzhou , Jiangsu (CN); Jia Gu, Suzhou , Jiangsu (CN); Shixin Liu, Suzhou , Jiangsu (CN); LONG CHEN, Suzhou, Jiangsu (CN)

(21) Appl. No.: 18/880,463

(22) PCT Filed: Jun. 6, 2023
(86) PCT No.: PCT/CN2023/098473

§ 371 Date: Dec. 31, 2024

(30) Foreign Application Priority Data
Jul. 1, 2022 (CN) 202221691765.0

(51) Int. Cl. G02B 6/42; H04B 10/40

(52) U.S. Cl. CPC G02B 6/428; G02B 6/4246; G02B 6/4271; H04B 10/40

(57) ABSTRACT

A multi-channel light receiving/transmitting assembly and an optical module. The multi-channel light receiving/transmitting assembly comprises a base (310), a conductive substrate, a light transmitting assembly, and a light receiving assembly; the conductive substrate is at least partially connected with the base (310); the light transmitting assembly is used for transmitting an optical signal, and the light transmitting assembly comprises at least two laser chips (510), wherein the laser chips (510) are arranged on the base (310) in parallel in a first direction (X) and are respectively electrically connected with the conductive substrate; the light receiving assembly is used for receiving an externally inputted optical signal, and the light receiving assembly comprises at least two light receiving chips (610), wherein the light receiving chips (610) are arranged on the conductive substrate in parallel in the first direction (X) and are respectively electrically connected with the conductive substrate; the light transmitting assembly and the light receiving assembly are staggered in a second direction (Y), the second direction (Y) is perpendicular to the first direction (X), and the second direction (Y) and the first direction (X) are both parallel to the upper surface of the base (310), so as to solve the technical problem of difficulty in expanding more channels due to the fact that a device of a traditional light transmitting assembly occupies a relatively large space.

### CROSS-REFERENCE TO RELATED PATENT APPLICATION

The present disclosure claims priority to the Chinese patent application filed with the China Patent Office on Jul. 1, 2022, with the application Ser. No. 20/222,1691765.0 and the invention name “MULTI-CHANNEL OPTICAL TRANSCEIVER ASSEMBLY AND OPTICAL MODULE”, the entire content of which is incorporated into the present disclosure by reference.

### FIELD OF THE DISCLOSURE

The present disclosure relates to the field of optical communication technology, and specifically to a multi-channel optical transceiver assembly and an optical module.

### BACKGROUND TECHNIQUE

The packaging of optical modules comprises hermetic packaging and non-hermetic packaging. Among these, non-hermetic packaging is suitable for data centers, while hermetic packaging is designed for harsh outdoor environments, such as those required for 5G communications. As the construction and use of communication networks and data centers increase, the demand for higher network speeds is gradually rising. In the prior art, multi-channel packaged optical communication devices mostly adopt a four-channel BOX packaging method. Optical communication devices generally increase bandwidth by raising the rate of a single channel. However, as the speed of optical transmitting components increases, the number of hermetically sealed channels continues to grow, the traditional BOX package, which comprises two casings: an optical transmitting sub-module and an optical receiving sub-module, faces challenges. Specifically, the spacing between receiving channels in the optical module is generally 750 μm, while the spacing between emitting channels is typically around 750 μm to 1 mm. Consequently, the arrangement of devices in traditional optical-transmitting assembly occupies a large amount of space, making it difficult to expand to accommodate more channels.

### SUMMARY OF THE DISCLOSURE

### Technical Problem

The present disclosure provides a multi-channel optical transceiver assembly and an optical module to solve the technical problem that the arrangement of devices in traditional optical transmitting assembly occupies a large space, making it difficult to expand more channels.

### Technical Solutions

The present disclosure provides a multi-channel optical transceiver assembly, comprising a base, a conductive substrate, an optical-transmitting assembly and an optical-receiving assembly. The conductive substrate is at least partially overlapping the base. The optical-transmitting assembly is configured to emit optical signals. The optical-transmitting assembly comprises at least two laser chips. The at least two laser chips are arranged side by side on the base along a first direction and electrically connected to the conductive substrate respectively. The optical-receiving assembly is configured to receive optical signals input from outside. The optical-receiving assembly comprises at least two optical-receiving chips, and the at least two optical-receiving chips are arranged side by side on the conductive substrate along a first direction and electrically connected to the conductive substrate respectively. The optical-transmitting assembly and the optical-receiving assembly are arranged in a staggered manner along a second direction, the second direction is perpendicular to the first direction, and both the first direction and the second direction are parallel to the upper surface of the base.

Optionally, one end of the conductive substrate is adjacent to the laser chip and provided with an transmitting-end electrical connection portion, and the transmitting-end electrical connection portion is electrically connected to the optical-transmitting assembly; the conductive substrate is further provided with a receiving-end electrical connection portion, the receiving-end electrical connection portion is electrically connected to the optical-receiving assembly, the optical-receiving chips and the receiving-end electrical connection portion are located on the conductive substrate and on a side of the transmitting-end electrical connection portion that is away from the laser chip.

Optionally, the conductive substrate comprises: a multilayer ceramic substrate including a first end portion and a second end portion oppositely arranged, wherein the first end portion is overlapped to the base; wherein, the laser chip and an optical-receiving chip are both electrically connected to the first end portion.

Optionally, the first end comprises a first plane and a step surface lower than the first plane, the transmitting-end electrical connection portion is located on the step surface, and the optical-receiving chip and the receiving-end electrical connection portion are located on the first plane.

Optionally, the second end portion comprises a second plane and a third plane disposed opposite to each other, the second plane and the third plane are respectively provided with conductive traces extending to the first end portion; wherein, the transmitting-end electrical connection portion and the receiving-end electrical connection portion are both electrically connected to the conductive traces of the second plane and/or the conductive trace of the third plane; and he conductive substrate further comprises a main control circuit board, a first circuit board and a second circuit board, wherein the main control circuit board is electrically connected to the conductive trace of the second plane and the conductive trace of the third plane via the first circuit board and the second circuit board, respectively.

Optionally, the conductive substrate comprises: a main control circuit board and an electrical adapter board. The receiving-end electrical connection portion is located on an upper surface of the main control circuit board, one end of the electrical adapter board is adjacent to the laser chips and the one end of the electrical adapter board is provided with the transmitting-end electrical connection portion, and another end of the electrical adapter plate is electrically connected to a lower surface of the main control circuit board.

Optionally, the main control circuit board comprises: receiving-end signal lines and transmitting-end signal lines. The receiving-end signal lines are disposed on the upper surface of the main control circuit board and electrically connected to the receiving-end electrical connection portion. The transmitting-end signal lines are disposed on a lower surface of the main control circuit board. The transmitting-end electrical connection portion is provided on an upper surface of the electrical adapter board, an upper surface of another end of the electrical adapter board is attached to the lower surface of the main control circuit board and electrically connected to the transmitting-end signal lines to electrically connect the transmitting-end signal lines and the transmitting-end electrical connection portion.

Optionally, the conductive substrate comprises the main control circuit board, wherein one end of the main control circuit board is overlapped to the base, a step portion is provided at the one end of the main control circuit board, and the step portion is adjacent to the laser chip; wherein, an upper surface of the step portion is lower than the upper surface of the main control circuit board, the transmitting-end electrical connection portion is located on the upper surface of the step portion, and the optical-receiving chip and the receiving-end electrical connection portion is located on the upper surface of the main control circuit board.

Optionally, the multi-channel optical transceiver assembly further comprises a first housing, and the first housing comprises an optical window and an electrical interface, wherein one end of a conductive base is overlapped to the base in the first housing and another end of the conductive base extends to the outside of the first housing through the electrical interface.

Optionally, the multi-channel optical transceiver assembly further comprises a transmitting-end optical processing unit and a receiving-end optical processing unit. The transmitting-end optical processing unit is configured to combine signal lights emitted by each of the laser chips and the receiving-end optical processing unit is configured to demultiplex composite signal light input from outside and output demultiplexed signal lights, and transmit the demultiplexed signal lights to each of the optical-receiving chips.

Optionally, the receiving-end optical processing unit is at least partially stacked on the transmitting-end optical processing unit.

Optionally, the multi-channel optical transceiver assembly further comprises a first optical fiber adapter and a second optical fiber adapter. The first optical fiber adapter is disposed in the optical window of the first housing and optical connected to the transmitting-end optical processing unit and the second optical fiber adapter is disposed in the optical window of the first housing and connected to the receiving-end optical processing unit.

Optionally, the optical receiving assembly further comprises: coupling lenses and a reflecting mirror. The coupling lenses are disposed opposite to a light exit surface of the receiving-end optical processing unit and the reflecting mirror is disposed opposite to the coupling lens; wherein, each split beam processed by the receiving-end optical processing unit is separately transmitted to each of the coupling lenses, and is transmitted to each of the optical-receiving chips after being deflected by the reflecting mirror.

Optionally, the optical-transmitting assembly further comprises: a thermoelectric cooler disposed on the base and carrying the laser chips; wherein, the base is a heat sink.

Correspondingly, the present disclosure further provides an optical module, which comprises a multi-channel optical transceiver assembly and a second housing. The multi-channel optical transceiver assembly is the multi-channel optical transceiver assembly described in any one of the above, and the multi-channel optical transceiver assembly is installed in the second housing.

### Beneficial Effects

The present disclosure provides a multi-channel optical transceiver assembly and optical module. A plurality of laser chips are arranged side by side on a base along a first direction, while a plurality of optical-receiving chips are arranged side by side on a conductive substrate along the same first direction. The conductive substrate at least partially overlaps the base. In addition, the optical-transmitting assembly and the optical-receiving assembly are arranged in a staggered manner along a second direction, where the first direction and the second direction are perpendicular to each other and parallel to the upper surface of the base. This arrangement enables the optical module to accommodate more channels for emitting and receiving light within a limited space. By utilizing the conductive substrate and the base with different heights, the optical-receiving assembly and optical-transmitting assembly are positioned on planes of different heights. This design staggers the electrical signal transmission paths of the transmitting end and the receiving end, thereby reducing electrical signal crosstalk between the transmitting end and the receiving end, and effectively improving the high-frequency performance of the optical module. In addition, the staggered arrangement of the optical-transmitting assembly and the optical-receiving assembly along the second direction ensures that there is no interference between the respective components of optical-transmitting assembly and optical-receiving assembly. Therefore, the arrangement of the optical-transmitting assembly and optical-receiving assembly described in the present disclosure facilitates the implementation of a multi-channel parallel small-package structure.

### BRIEF DESCRIPTION OF THE DRAWINGS

In order to more clearly illustrate the technical solutions of the embodiments of the present disclosure, the drawings needed to be used in the description of the embodiments will be briefly introduced below. The drawings in the following description are only some embodiments of the present disclosure. For those skilled in the art, as far as workers are concerned, other drawings can also be obtained based on these drawings without exerting creative work.

FIG. 1 is a schematic structural diagram of the optical module provided in this embodiment;

FIG. 2 is an exploded schematic diagram of the optical module provided in this embodiment;

FIG. 3 is a schematic structural diagram of the multi-channel airtight packaging structure provided by this embodiment;

FIG. 4 is a partial structural schematic diagram of the multi-channel airtight packaging structure provided by this embodiment;

FIG. 5 is a partial structural diagram of the multi-channel airtight packaging structure provided by this embodiment;

FIG. 6 is a schematic side view of the multi-channel airtight packaging structure provided by this embodiment;

FIG. 7 is a schematic structural diagram of the multi-channel non-hermetic packaging structure provided by this embodiment;

FIG. 8 is an enlarged schematic diagram of part A in FIG. 7.

### EXPLANATION OF REFERENCE NUMERALS

100. Second housing; 110. Upper housing; 120. Lower housing; 210. Main control circuit board; 220. First circuit board; 230. Second circuit board; 300. First housing; 310. Base 320. optical window; 330. Electrical interface; 400. Digital signal processor; 510. Laser chip; 511. Optical-transmitting surface; 520. thermoelectric cooler; 530. First collimating lens; 540. First fiber adapter; 550. First coupling lens; 610. optical-receiving chip; 611. Receiving surface; 620. Second collimating lens; 630. Second fiber adapter; 640. Transimpedance amplifier; 650. Second coupling lens; 660. Reflecting mirror; 710. Combiner; 711. Light incident surface; 720. Wave splitter; 721. Light exit surface; 800. Multilayer ceramic substrate; 810. First plane; 820. Second plane; 830. Third plane; 840. Step surface; 900, electrical adapter board.

### DETAILED DESCRIPTION OF THE EXEMPLARY EMBODIMENTS

The technical solutions in the embodiments of the present disclosure will be clearly and completely described below with reference to the accompanying drawings in the embodiments of the present disclosure. It is evident that the described embodiments are merely some examples of the embodiments of the present disclosure, rather than all possible embodiments. Based on the embodiments disclosed herein, all other embodiments that can be obtained by those skilled in the art without requiring creative efforts fall within the scope of protection of the present disclosure. Additionally, it should be understood that the specific embodiments described herein are provided solely to illustrate and explain the application and are not intended to limit its scope. In the present disclosure, unless otherwise specified, directional terms such as “upper,” “lower,” “left,” and “right” typically refer to the upper, lower, left, and right positions of the device during actual use or operation. Specifically, these directional terms correspond to the orientation depicted in the accompanying drawings.

The present disclosure provides a multi-channel optical transceiver assembly and optical module, which are described in detail below. It should be noted that the description order of the following embodiments does not limit the preferred order of the embodiments of the present disclosure. In the following embodiments, each embodiment is described with its own emphasis. For parts that are not described in detail in a certain embodiment, please refer to the relevant descriptions of other embodiments.

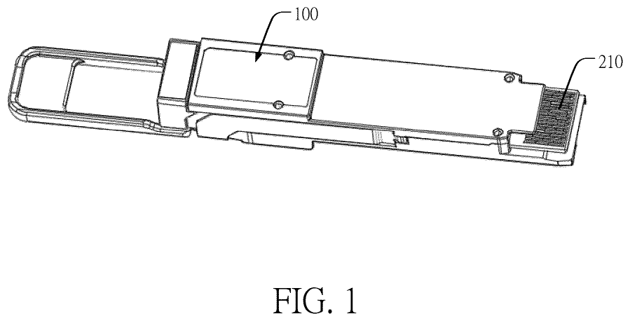

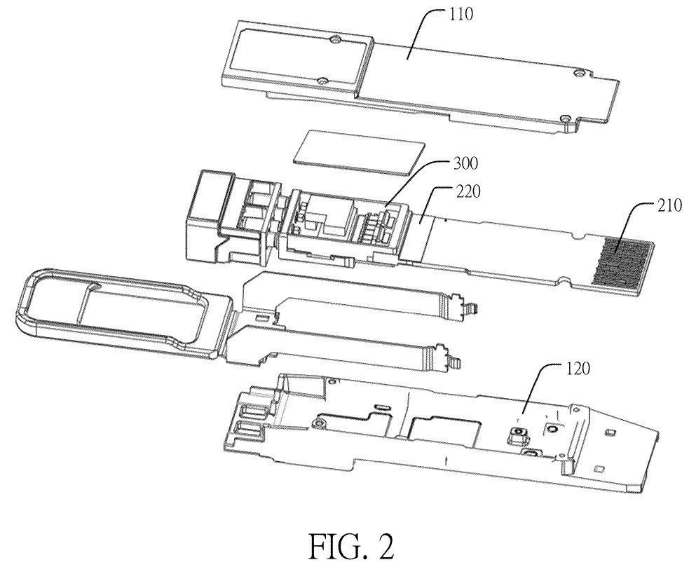

Referring to FIGS. 1 and 2, the present disclosure provides an optical module, which comprises a second housing 100 and a multi-channel optical transceiver assembly. The second housing 100 is composed of an upper housing 110 and a lower housing 120. The upper housing 110 is covered above the lower housing 120 and forms a cavity including an electrical port and an optical port. The above-mentioned multi-channel optical transceiver assembly is disposed inside the cavity.

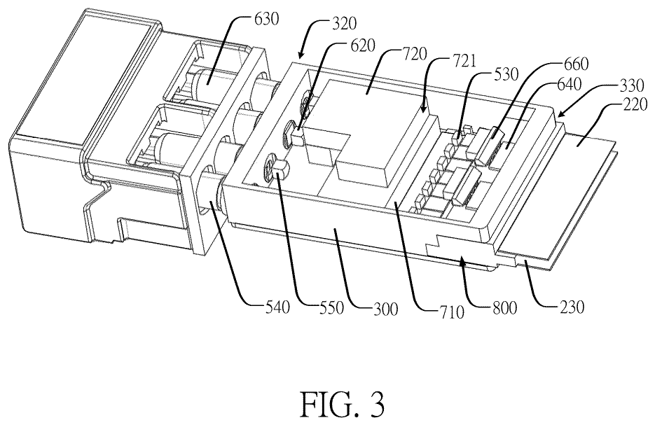

Referring to FIGS. 3-5, an optical transceiver assembly is provided taking a multi-channel hermetic packaging structure as an example. The above-mentioned optical transceiver assembly comprises a first housing 300, an optical-transmitting assembly, an optical-receiving assembly and a conductive substrate, wherein the first housing 300 comprises a base 310 at the bottom. The optical-transmitting assembly and the optical-receiving assembly are both located inside the first housing 300. The optical-transmitting assembly is configured to emit optical signals. The optical-transmitting assembly comprises at least two laser chips 510, and all the laser chips 510 are arranged side by side on the upper surface of the base 310 along the first direction X. The optical-receiving assembly is configured to receive signal light input from outside. The optical-receiving assembly comprises at least two optical-receiving chips 610, and all the optical-receiving chips 610 are arranged side by side on the upper surface of the conductive substrate along the first direction X. In this embodiment, the laser chip refers to a COC (chip on carrier), which comprises a semiconductor laser chip and a soldering substrate carrying the semiconductor laser chip.

Referring to FIGS. 3-5, the optical-transmitting assembly and the optical-receiving assembly are arranged in a staggered manner along the second direction Y. The second direction Y is perpendicular to the first direction X, and both directions are parallel to the upper surface of the base 310. This arrangement effectively prevents the optical path of the optical-transmitting assembly from interfering with the optical path of the optical-receiving assembly.

Referring to FIGS. 2-5, the conductive substrate comprises a conductive multilayer ceramic substrate 800 and a main control circuit board 210. The multilayer ceramic substrate 800 comprises a first end portion and a second end portion that are oppositely arranged, wherein the first end portion is inserted into the first housing 300 and overlapped with the upper surface of the base 310. The first housing 300 comprises an optical window 320 and an electrical interface 330 disposed opposite to each other. The second end portion extends to the outside of the first housing 300 through the electrical interface 330 of the first housing 300 and is electrically connected to the main control circuit board 210.

Referring to FIGS. 3-5, the above-mentioned optical-transmitting assembly is located on the top surface of the base 310, and the optical-receiving assembly is located on the first plane 810 of the multilayer ceramic substrate 800. The laser chips 510 of the optical-transmitting assembly are arranged at equal intervals on the base 310 and are electrically connected to the multilayer ceramic substrate 800. Each laser chip 510 is provided with a optical-transmitting surface 511 for emitting signal light by using the laser chip 510. Generally, the optical-transmitting assembly comprises a laser chip 510, a collimating lens (LD lens), a thermoelectric cooler 520 (TEC), a laser driver and other devices that assist in generating signal light.

Meanwhile, referring to FIGS. 3-5, a plurality of optical-receiving chips 610 in the optical-receiving assembly are arranged at equal intervals on the first plane 810 of the multilayer ceramic substrate 800 and are electrically connected to the multilayer ceramic substrate 800. Each optical-receiving chip 610 is provided with a receiving surface 611 for receiving signal light from outside of the multi-channel optical transceiver assembly by using the optical-receiving chip 610. Generally, the optical-receiving assembly comprises a second coupling lens 650, an optical-receiving chip 610, a transimpedance amplifier 640 (TIA) and other devices for receiving signal light and assisting in photoelectric conversion.

Referring to FIGS. 2-5, the first end portion of the multilayer ceramic substrate 800 comprises a first plane 810 and a step surface 840 lower than the first plane 810. The step surface 840 of the first end portion is adjacent to the laser chip 510, the step surface 840 is provided with a transmitting-end electrical connection portion, and the laser chips 510 are electrically connected to the transmitting-end electrical connection portion, so that the optical-transmitting assembly is electrically connected to the main control circuit board 210 through the transmitting-end electrical connection portion. A receiving-end electrical connection portion is provided on the first plane 810, and the optical-receiving chips 610 are electrically connected to the main control circuit board 210, so that the optical-receiving assembly is electrically connected to the main control circuit board 210 through the receiving-end electrical connection portion.

Referring to FIGS. 3-5, the transmitting-end electrical connection portion on the step surface 840 can be electrically connected to the laser chip 510 disposed on the base 310 through bonding wires. In this embodiment, the height of the surface pad on the step surface 840 can be approximately the same as the height of the pad on the surface of the soldering substrate carrying the semiconductor laser chip, ensuring that the bonding wires between the two is minimized. In addition, the optical-receiving chips 610 and the transimpedance amplifier 640 are both positioned on the first plane 810, and the receiving-end electrical connection portion can also be electrically connected to the transimpedance amplifier 640 through bonding wires. The transimpedance amplifier 640 is electrically connected to the optical-receiving chips 610 via bonding wires. Since the step surface 840 is lower than the first plane 810, the optical-receiving assembly and the light-transmitting component are positioned on planes at different heights of the multilayer ceramic substrate 800. This arrangement staggers the electrical signal transmissions of the transmitting-end and the receiving-end, thereby reducing signal crosstalk between the transmitting-end and the receiving-end, and effectively improving the high-frequency performance of optical modules.

Referring to FIGS. 3-5, the step surface 840 and the first plane 810, which are at different heights, are used to achieve the hierarchical arrangement of the laser chips 510 and the optical-receiving chips 610. This arrangement effectively utilizes the vertical space within the first housing 300, thereby reducing to occupy the flat space and enabling an increase in the number of optical channels without altering the overall size of the optical module. Besides, this configuration reduces electrical signal crosstalk between the optical receiving end and the optical transmitting end, ensuring the high-frequency performance of the product. Additionally, the optical-transmitting assembly and the optical-receiving assembly are arranged in a staggered manner along the second direction, ensuring that no interference occurs between the components of the optical-transmitting assembly and the components of the optical-receiving assembly. Therefore, by utilizing the arrangement of the optical-transmitting assembly and optical-receiving assembly described in the present disclosure, it becomes feasible to realize a multi-channel parallel small package structure, allowing for compact optical module packaging with 8 or more channels.

Referring to FIGS. 3-5, the second end of the multilayer ceramic substrate 800 comprises a second plane 820 and a third plane 830, both arranged parallel to the top surface of the base 310. The second plane 820 is positioned opposite to the third plane 830. The second plane 820 and the third plane 830 are respectively provided with conductive traces extending to the first end portion of the multilayer ceramic substrate 800. The receiving-end electrical connection portion on the first plane 810 and the transmitting-end electrical connection portion on the step surface 840 are electrically connected to the conductive traces on the second plane 820 and/or the third plane 830 of the multilayer ceramic substrate 800, respectively. In the present disclosure, the specific electrical connection positions of the laser chip 510 and the optical-receiving chip 610 can be selected based on the actual layout requirements.

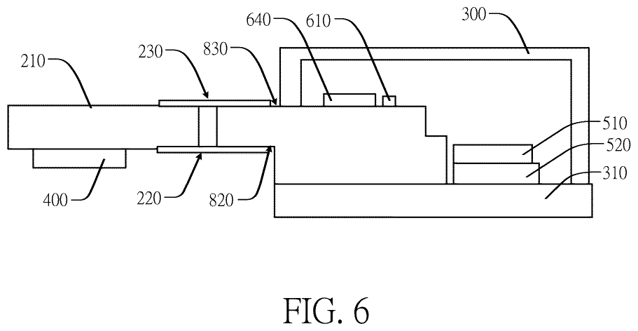

Referring to FIGS. 3-6, the above-mentioned conductive substrate further comprises a first circuit board 220 and a second circuit board 230. In the present disclosure, the first circuit board 220, the main control circuit board 210, and the second circuit board 230 are arranged sequentially. The second plane 820 of the multilayer ceramic substrate 800 is electrically connected to one surface of the main control circuit board 210 through the first circuit board 220, while the third plane 830 of the multilayer ceramic substrate 800 is electrically connected to another opposite surface of the main control circuit board 210 through the second circuit board 230. The positions where the first circuit board 220 and the second circuit board 230 are electrically connected to the main control circuit board 210 can be exchanged. The first circuit board 220 comprises transmitting-end signal lines and receiving-end signal lines. Correspondingly, the second plane 820 is provided with transmitting-end signal lines and welding pads, and further provided with receiving-end signal lines and welding pads. The transmitting-end signal lines and the receiving-end signal lines of the first circuit board 220 are respectively aligned with and connected to the transmitting-end pads and the receiving-end pads on the second plane 820 to transmit high-frequency signals of the transmitting-end and the receiving-end. Additionally, an electrical isolator, such as an electrically isolated ground wire, can be provided between the transmitting-end signal lines and the receiving-end signal lines on the first circuit board 220. The use of this electrical isolator can further reduce electrical signal crosstalk between the transmitting-end and the receiving-end.

Referring to FIGS. 3-6, the second circuit board 230 comprises a first power supply line and a second power supply line. Correspondingly, the third plane 830 of the multilayer ceramic substrate 800 is provided with power supply lines and pads. The first power supply line is electrically connected to the corresponding pads on the third plane 830 to supply power to the laser chips 510 and the thermoelectric cooler 520. The second power supply line is electrically connected to the corresponding pads on the third plane 830 to supply power to the optical-receiving chips 610 and the transimpedance amplifier 640. In alternative embodiments, the receiving-end signal lines and the second power supply line may be provided on the third plane 830 of the multilayer ceramic substrate 800, while the transmitting-end signal lines and the first power supply line may be provided on the second plane 820. Correspondingly, the first circuit board 220 is configured to transmit high-frequency signals and supply power for the transmitting-end, and the second circuit board 230 is configured to transmit high-frequency signals and supply power for the receiving-end. The first circuit board 220 and the second circuit board 230 can be implemented as flexible circuit boards or metal conductive pins.

Referring to FIGS. 3-6, the optical module further comprises a digital signal processor 400 and a power supply chip (not shown in the figures). The above-mentioned digital signal processor 400 is electrically connected to the main control circuit board 210. The first circuit board 220 is electrically connected to the digital signal processor 400 via the main control circuit board 210, and the second circuit board 230 is electrically connected to the digital signal processor 400 or the power supply chip through the main control circuit board 210. Wherein, the digital signal processor 400 and the first circuit board 220 are located on the same surface of the main control circuit board 210 to facilitate the routing of the first signal lines and the second signal lines on the first circuit board 220. In the present disclosure, the digital signal processor 400 and the first circuit board 220 are located on the bottom surface of the main control circuit board 210, thereby improving the heat dissipation performance.

Referring to FIGS. 3-5, the multi-channel optical transceiver assembly further comprises a transmitting-end optical processing unit and a receiving-end optical processing unit, wherein the transmitting-end optical processing unit is configured to combine the signal lights emitted by each of the laser chips. The transmitting-end optical processing unit of the present disclosure is a combiner 710. The receiving-end optical processing unit is configured to demultiplex the composite signal light input from outside and output demultiplexed signal lights and transmit the demultiplexed signal lights to each of the optical receiving chips. In the present disclosure, the receiving-end optical processing unit is a splitter 720.

Referring to FIGS. 3-5, the combiner 710 comprises a light incident surface 711, which is positioned opposite to the optical-transmitting surface 511 of the laser chip 510. After the signal light emitted by the laser chip 510 is collimated by the first collimating lens 530, it enters the light incident surface 711 of the combiner 710. The combiner 710 is configured to combine signal lights with different wavelengths emitted by different laser chips 510 into a single beam. The combined light beam is then transmitted to the outside of the packaging structure through the optical window of the first housing 300. In the illustrated embodiment, the combiner 710 is able to combines the signal lights generated by eight sets of laser chips 510 into two beams, which are then transmitted to two fiber adapters (optical receptacles) through two first coupling lenses 550, respectively. The combined signals are subsequently transmitted to the outside via the fiber adapters. It should be noted that the number of laser chips 510 and the number of fiber adapters are not limited to the example provided above.

Referring to FIGS. 3-5, the wavelength splitter 720 comprises a light exit surface 721, which is positioned opposite to the second coupling lens 650 of the optical-receiving chip 610. Signal light from outside the package structure is collimated by the second collimating lens 620 before being transmitted to the wavelength splitter 720. The wavelength splitter 720 is configured to demultiplex the signal light into multiple demultiplexed signals with different wavelengths, which are then output through the light exit surface 721. These demultiplexed signals are transmitted to a plurality of second coupling lenses 650, and deflected by 90 degrees via a reflecting mirror 660, to subsequently vertically incident to the receiving surface 611 of different optical-receiving chips 610. In the illustrated embodiment, the splitter 720 divides two signal lights transmitted by the fiber adapter into eight channels of demultiplexed signal light, which are then respectively transmitted to eight optical-receiving chips 610. Each four of the eight optical-receiving chips 610 forms a group, with each group corresponding to a four-channel transimpedance amplifier (TIA) chip 640. The optical-receiving chips 610 convert the signal lights received into electrical signals and transmit these signals to the corresponding transimpedance amplifiers 640. The electrical signals are then amplified by the transimpedance amplifiers 640, before transmitted to the multilayer ceramic substrate 800, and further relayed from the multilayer ceramic substrate 800 to the circuit board of the optical module. It should be noted that the number of optical-receiving chips 610 and fiber adapters is not limited to the example provided above.

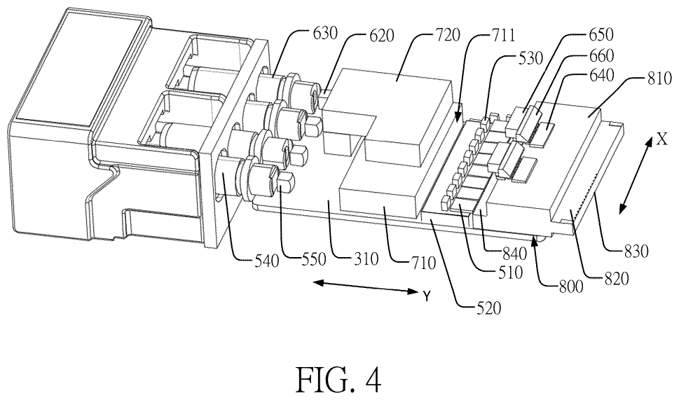

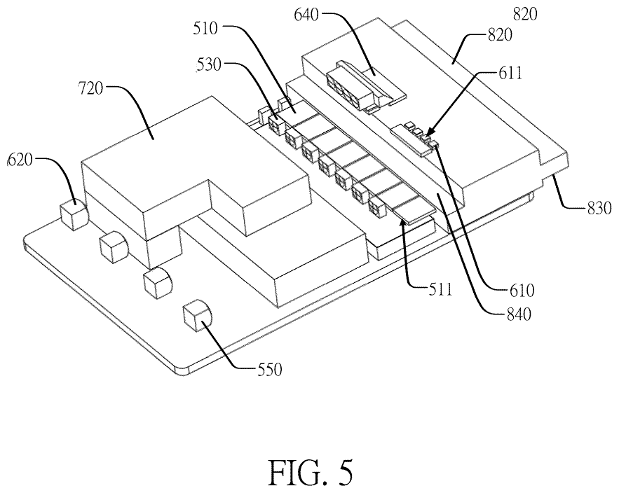

Referring to FIGS. 4 and 5, the optical-transmitting assembly further comprises a thermoelectric cooler 520 (TEC), which is disposed on the top surface of the base 310 and used to carry a plurality of laser chips 510. In the multi-channel airtight packaging structure in this embodiment, the base 310 is a heat sink made of metal parts with good heat dissipation. Of course, in some embodiments, the laser chips 510 can also be placed directly on the heat sink of the base 310.

Referring to FIGS. 4 and 5, the laser chips 510 are disposed on the top surface of the base 310 through the cooler 520, so that the heat generated by the laser chip 510 is conducted to the outside of the first housing 300 through the thermoelectric cooler 520 and then through the base 310.

Referring to FIGS. 3-5, the laser chips 510 are arranged side by side along the first direction X, the optical-receiving chips 610 are arranged side by side along the first direction X, and the optical-transmitting assembly and the optical-receiving assembly are arranged in a staggered manner along the second direction Y. Wherein, the transmitting-end electrical connection portion is located on the step surface 840, and the receiving-end electrical connection portion is located on the first plane 810, so that the laser chips 510 and the optical-receiving chips 610 are at different heights. The thermoelectric cooler 520 for temperature control is provided below the laser chips 510, and the thermoelectric cooler 520 is placed on the base 310 with good heat dissipation performance, which can not only meet the heat dissipation performance requirements of the laser chips 510, but also maximize the utilization of the space in the height direction within the first housing 300, and makes it easier to implement a multi-channel parallel packaging structure.

Referring to FIG. 4, the multi-channel optical transceiver assembly further comprises a first fiber adapter 540 and a second fiber adapter 630, wherein the first fiber adapter 540 and the second fiber adapter 630 are both disposed outside the first housing 300. The first fiber adapter 540 is optically connected to the combiner 710 through the optical window 320 of the first housing 300, and is configured to transmit the optical signal emitted by the laser chips 510. The second fiber adapter 630 is optically connected to the splitter 720 through the optical window 320 of the first housing 300, and is configured to receive composite optical signals from outside and transmit the composite optical signals to the inside of the optical module. The number of the first fiber adapter 540 and the second fiber adapter 630 is not limited, and may be one, two, or four.

Referring to FIGS. 3-5, the signal light collimated by the first collimating lens 530 is directed onto the light incident surface 711 of the combiner 710 for multiplexing. The first fiber adapter 540 is positioned opposite to the exit window of the combiner 710, allowing the combined composite light beam to be transmitted to outside through the first fiber adapter 540. Similarly, since the second fiber adapter 630 is aligned with the entrance window of the splitter 720, external signal light is transmitted to the splitter 720 via the second fiber adapter 630, where it undergoes demultiplexing. The demultiplexed signal lights are then transmitted to the corresponding optical-receiving chips 610.

Referring to FIG. 4, the demultiplexer 720 is at least partially stacked on the combiner 710, which can further reduce the space occupied in the plane. Specifically, the combiner 710 is disposed on the top surface of the base 310, the part of the demultiplexer 720 adapted to the fiber adapter is disposed on the top surface of the base 310, and the other parts of the demultiplexer 720 are disposed on the top surface of the combiner 710. A deflection prism is provided between the splitter 720 and the second fiber adapter 630 for deflecting the composite beam input from the second fiber adapter 630 to the splitter 720 to realize the optical connection between the splitter 720 and the second fiber adapter 630. In other embodiments, the transmitting-end optical processing unit and the receiving-end optical processing unit can also use arrayed waveguide gratings (AWG), polarizing beam splitting prisms (PBS), or free space thin film filters to perform light combining or splitting processing. The present disclosure is not limited thereto.

The above explanation is based on the airtight packaging structure as an example, and the following is a non-airtight packaging structure as an example.

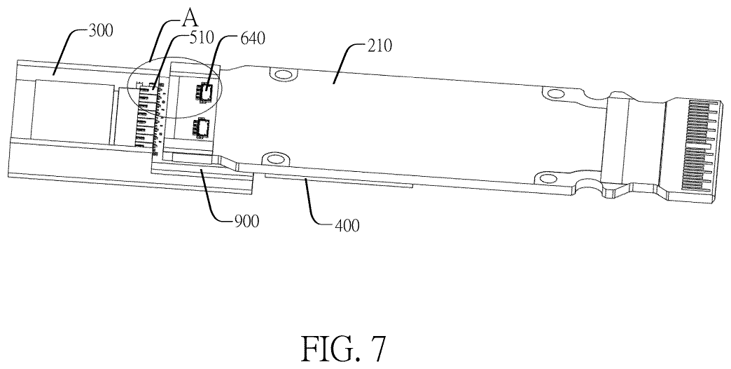

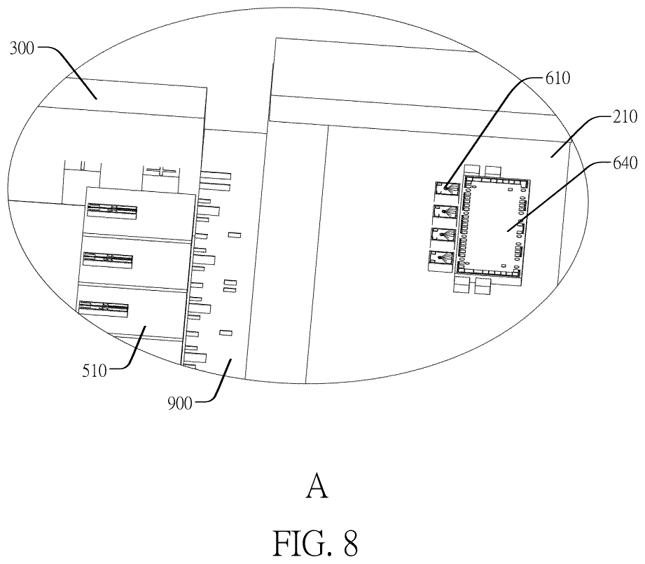

Referring to FIGS. 7 and 8, the optical transceiver assembly includes a first housing 300, an optical-transmitting assembly, an optical-receiving assembly and a conductive substrate. The structures of the first housing 300, the optical-transmitting assembly and the optical-receiving assembly are the same as the technical features disclosed in the hermetically sealed structure as described above, except that in this embodiment the conductive substrate comprises a main control circuit board 210 and an electrical adapter board 900, at least part of the electrical adapter board 900 overlaps the upper surface of the base 310. The receiving-end electrical connection is located on the upper surface of the main control circuit board 210. One end of the electrical adapter board 900 is disposed adjacent to the laser chips 510, and this end is provided with a transmitting-end electrical connection portion, while the other end of the electrical adapter plate 900 is electrically connected to the lower surface of the main control circuit board 210.

One end of the electrical adapter board 900 is electrically connected to the lower surface of the main control circuit board 210, positioning the height of the electrical adapter board 900 below that of the main control circuit board 210. Since the receiving-end electrical connection portion is located on the upper surface of the main control circuit board 210, and the transmitting-end electrical connection portion is located on the upper surface of the electrical adapter board 900, the optical-receiving assembly and the optical-transmitting assembly are positioned on planes with different heights. This arrangement staggers the electrical signal transmission paths of the transmitting-end and receiving-end, which reduces the electrical signal crosstalk between the transmitting-end and the receiving-end, effectively improving the high-frequency performance of the optical module.

The main control circuit board 210 comprises a receiving-end signal lines and a transmitting-end signal lines. The receiving-end signal lines are disposed on the upper surface of the main control circuit board 210 and are electrically connected to the optical-receiving assembly through the receiving-end electrical connection portion. The transmitting-end signal lines are disposed on the lower surface of the main control circuit board 210 and are electrically connected to the optical-transmitting assembly through the transmitting-end electrical connection portion. In addition, an electrical isolator can be provided between the transmitting-end signal lines and the receiving-end signal lines on the main control circuit board 210. The use of the above electrical isolator can further reduce electrical signal crosstalk between the transmitting-end and the receiving-end.

By utilizing the main control circuit board 210 and the electrical adapter board 900 with different heights to achieve the hierarchical arrangement of the laser chip 510 and the optical-receiving chip 610, the space in the height direction within the first housing 300 can be effectively utilized. This arrangement reduces space occupied in the plane, allowing an increase in the number of optical channels without altering the size of the optical module. In addition, it minimizes the crosstalk of electrical signals between the optical receiving-end and the optical transmitting-end, thereby ensuring the high-frequency performance of the product. Furthermore, the optical-transmitting assembly and the optical-receiving assembly are arranged in a staggered manner along the second direction, thereby preventing interference between the components of the optical-transmitting assembly and those of the optical-receiving assembly. Therefore, through the arrangement of the optical-transmitting assembly and optical-receiving assembly described in the present disclosure, it is possible to easily realize a multi-channel parallel small package structure, enabling the small packaging of optical modules with 8 or more channels.

The above explanation uses the non-hermetic packaging structure as an example. In this embodiment, apart from the structure of the conductive substrate and the corresponding positions of the optical-transmitting assembly and the optical-receiving assembly on the conductive substrate, the rest of the optical structure remains the same as the aforementioned hermetic packaging structure. Therefore, further details are not elaborated here.

The following example describes another non-airtight package. The optical transceiver assembly comprises a first housing 300, a optical-transmitting assembly, an optical-receiving assembly, and a conductive substrate. The structures of the first housing 300, the optical-transmitting assembly, and the optical-receiving assembly are identical to the technical features disclosed in the aforementioned airtight packaging structure. The difference in this embodiment lies in the conductive substrate, which comprises a main control circuit board 210. One end of the main control circuit board 210 overlaps with the base 310, where a step portion (not shown in the figures) is provided, and adjacent to the laser chip 510.

The upper surface of the step portion is lower than the upper surface of the main control circuit board 210. The transmitting-end electrical connection portion is located on the upper surface of the step portion, while the receiving-end electrical connection portion is located on the upper surface of the main control circuit board 210. The laser chips 510 are disposed on the base 310 and are electrically connected to the main control circuit board 210 through the transmitting-end electrical connection portion. The optical-receiving chips 610 and the transimpedance amplifier 640 are disposed on the upper surface of the main control circuit board 210, positioned behind the step portion. The transimpedance amplifier 640 is electrically connected to the main control circuit board 210 via the receiving-end electrical connection portion. By placing the optical-receiving assembly and the light-transmitting component on planes of different heights, the electrical signal transmissions of the transmitting-end and the receiving-end are staggered, thereby effectively reducing electrical signal crosstalk between the transmitting-end and the receiving-end, and significantly improving the high-frequency performance of the optical module.

The multi-channel optical transceiver assembly and the optical module provided by the present disclosure have been described in detail above. Specific examples are provided in this document to illustrate the principles and implementation methods of the present disclosure. The descriptions of the above embodiments are intended solely to facilitate understanding of the methods and core ideas of the present disclosure. At the same time, for those skilled in the art, modifications to specific implementation methods and the scope of applications may be made based on the principles of the present disclosure. In summary, the content of this specification should not be construed as imposing limitations on the applications of the present disclosure.

1. A multi-channel optical transceiver assembly, comprising:
a base (310);
a conductive substrate, at least partially overlapping the base (310);
an optical-transmitting assembly, configured to emit optical signals, wherein the optical-transmitting assembly comprises at least two laser chips (510), the at least two laser chips (510) are arranged side by side on the base (310) along a first direction (X) and electrically connected to the conductive substrate respectively; and
an optical-receiving assembly, configured to receive optical signals input from outside, wherein the optical-receiving assembly comprises at least two optical-receiving chips (610), and the at least two optical-receiving chips (610) are arranged side by side on the conductive substrate along the first direction (X) and electrically connected to the conductive substrate respectively;
wherein, the optical-transmitting assembly and the optical-receiving assembly are arranged in a staggered manner along a second direction (Y), the second direction (Y) is perpendicular to the first direction (X), and both the first direction (X) and the second direction (Y) are parallel to the upper surface of the base (310).

2. The multi-channel optical transceiver assembly according to claim 1, wherein:
one end of the conductive substrate is adjacent to the laser chip (510) and provided with an transmitting-end electrical connection portion, and the transmitting-end electrical connection portion is electrically connected to the optical-transmitting assembly;
the conductive substrate is further provided with a receiving-end electrical connection portion, the receiving-end electrical connection portion is electrically connected to the optical-receiving assembly, the optical-receiving chips and the receiving-end electrical connection portion are located on the conductive substrate and on a side of the transmitting-end electrical connection portion that is away from the laser chip (510).

3. The multi-channel optical transceiver assembly according to claim 2, wherein, the conductive substrate comprises:
a multilayer ceramic substrate (800) including a first end portion and a second end portion oppositely arranged, wherein the first end portion is overlapped to the base (310);
wherein, the laser chips (510) and a optical-receiving chips (610) are both electrically connected to the first end portion.

4. The multi-channel optical transceiver assembly according to claim 3, wherein:
the first end portion comprises a first plane (810) and a step surface (840) lower than the first plane (810), the transmitting-end electrical connection portion is located on the step surface (840), and the optical-receiving chips (610) and the receiving-end electrical connection portion are located on the first plane (810).

5. The multi-channel optical transceiver assembly according to claim 4, wherein:
the second end portion comprises a second plane (820) and a third plane (830) disposed opposite to each other, the second plane (820) and the third plane (830) are respectively provided with conductive traces extending to the first end portion;
wherein, the transmitting-end electrical connection portion and the receiving-end electrical connection portion are both electrically connected to the conductive traces of the second plane (820) and/or the conductive trace of the third plane (830); and
the conductive substrate further comprises a main control circuit board (210), a first circuit board (220) and a second circuit board (230), wherein the main control circuit board (210) is electrically connected to the conductive traces of the second plane (820) and the conductive traces of the third plane (830) via the first circuit board (220) and the second circuit board (230), respectively.

6. The multi-channel optical transceiver assembly according to claim 2, wherein, the conductive substrate comprises:
a main control circuit board (210), wherein the receiving-end electrical connection portion is located on an upper surface of the main control circuit board (210); and
an electrical adapter board (900), at least partially overlapping the base (310), wherein one end of the electrical adapter board (900) is adjacent to the laser chips (510) and the one end of the electrical adapter board (900) is provided with the transmitting-end electrical connection portion, and another end of the electrical adapter plate (900) is electrically connected to a lower surface of the main control circuit board (210).

7. The multi-channel optical transceiver assembly according to claim 6, wherein, the main control circuit board (210) comprises:
receiving-end signal lines disposed on the upper surface of the main control circuit board (210) and electrically connected to the receiving-end electrical connection portion; and
transmitting-end signal lines disposed on a lower surface of the main control circuit board (210), wherein the transmitting-end electrical connection portion is provided on an upper surface of the electrical adapter board (900), the upper surface of another end of the electrical adapter board (900) is attached to the lower surface of the main control circuit board (210) and electrically connected to the transmitting-end signal lines to electrically connect the transmitting-end signal lines and the transmitting-end electrical connection portion.

8. The multi-channel optical transceiver assembly according to claim 2, wherein, the conductive substrate comprises:
a main control circuit board (210), wherein one end of the main control circuit board (210) is overlapped to the base (310), a step portion is provided at the one end of the main control circuit board (210), and the step portion is adjacent to the laser chips (510);
wherein, an upper surface of the step portion is lower than the upper surface of the main control circuit board (210), the transmitting-end electrical connection portion is located on the upper surface of the step portion, and the optical-receiving chips (610) and the receiving-end electrical connection portion is located on the upper surface of the main control circuit board (210).

9. The multi-channel optical transceiver assembly according to claim 1, further comprising:
a first housing (300) including an optical window (320) and an electrical interface (330), wherein one end of a conductive base is overlapped to the base (310) in the first housing (300) and another end of the conductive base extends to the outside of the first housing (300) through the electrical interface (330).

10. The multi-channel optical transceiver assembly according to claim 9, further comprising:
a transmitting-end optical processing unit, configured to combine signal lights emitted by each of the laser chips (510); and
a receiving-end optical processing unit, configured to demultiplex a composite signal light input from outside and output demultiplexed signal lights, and transmit the demultiplexed signal lights to each of the optical-receiving chips (610).

11. The multi-channel optical transceiver assembly according to claim 10, wherein:
the receiving-end optical processing unit is at least partially stacked on the transmitting-end optical processing unit.

12. The multi-channel optical transceiver assembly according to claim 10, further comprising:
a first fiber adapter (540) disposed at the optical window (320) of the first housing (300) and optical connected to the transmitting-end optical processing unit; and
a second fiber adapter (630) disposed at the optical window (320) of the first housing (300) and optical connected to the receiving-end optical processing unit.

13. The multi-channel optical transceiver assembly according to claim 10, wherein, the optical-receiving assembly further comprises:
coupling lenses disposed opposite to a light exit surface (721) of the receiving-end optical processing unit; and
a reflecting mirror (660) disposed opposite to the coupling lens;
wherein, each split beam processed by the receiving-end optical processing unit is separately transmitted to each of the coupling lenses, and is transmitted to each of the optical-receiving chips (610) after being deflected by the reflecting mirror (660).

14. The multi-channel optical transceiver assembly according to claim 1, wherein, the optical-transmitting assembly further comprises:
a thermoelectric cooler (520) disposed on the base (310) and
carrying the laser chips (510);
wherein, the base (310) is a heat sink. An optical module, comprising:

15. a multi-channel optical transceiver assembly according to claim 1; and
a second housing (100), wherein the multi-channel optical transceiver assembly is located in the second housing (100).
